(19) United States
(12) Patent Application Publication
(10) Pub. No.: US 2008/0220145 A1
(43) Pub. Date: Sep. 11, 2008

(54) Method of producing parboiled rice and parboiled rice produced by the method

(75) Inventors: Takeshi Fukumori, Tokyo (JP); Shigeharu Kanemoto, Tokyo (JP); Keishi Wakabayashi, Tokyo (JP); Kengo Watanabe, Tokyo (JP); Junya Ishibashi, Tokyo (JP); Shinya Ochiai, Tokyo (JP)

Correspondence Address: JOSEPH P. FARRAR, ORION CONSULTING, LTD., KANDA CENTER BLDG., 5F 2-3-2 KAJCHO, CHIYODA-KU, TOKYO, 101-0044, JP

(73) Assignee: SATAKE CORPORATION, Tokyo (JP)

(21) Appl. No.: 12/073,473

(22) Filed: Mar. 6, 2008

(30) Foreign Application Priority Data
Mar. 9, 2007 (JP) 2007-060998
Jul. 25, 2007 (JP) 2007-193364

(51) Int. Cl. A23L 1/182

(52) U.S. Cl. 426/627; 426/461

(57) ABSTRACT

A method of producing parboiled rice that does not require waste water treatment equipment and that enriches the amount of γ-aminobutyric acid contained in the parboiled rice. The method includes partially milling raw material brown rice, wetting the partially milled rice grains by forced-air using moist air or mist, moisture-tempering the wetted rice grains, steam-boiling the water-tempered rice grains at normal pressure to heat the rice grains with steam, steam-boiling the rice grains heated in the normal pressure steam-boiling process using pressurized steam, cooling the rice grains steamed under pressure in the pressurized steam-boiling step to cool at least a surface of the rice grains, finish milling the rice grains cooled in the cooling step, and drying the finish-milled rice grains.

### BACKGROUND OF THE INVENTION

1. Field of the Invention

The present invention relates to a method of producing parboiled rice from brown rice of mainly long-grain and medium-grain, and the parboiled rice produced by such method.

2. Description of the Related Art

Conventionally, there are dried rice food products that can be returned to their cooked state within a short amount of time. One such type of dried rice product is parboiled rice. Parboiled rice is widely consumed in America and Europe as well as in Asian countries such as India and Pakistan. Parboiled rice is produced by steam-boiling the raw unhusked (unhulled) rice (paddy) as is, after which the cooked paddy is then dried, husked (hulled), and finally milled. When prepared for consumption, it is boiled in water for approximately 10-20 minutes.

However, because parboiled rice is produced by steam-boiling the raw unhusked rice as is, the odor and so forth of the chaff seeps into the endosperm, giving the rice grains a branny flavor.

Recently, consumer preferences with respect to the taste of parboiled rice have diversified, and the number of those consumers who dislike the branny flavor of parboiled rice has increased. In an effort to accommodate such changing tastes, parboiled rice without the branniness have been developed. As examples of such prior art there are the parboiled rice methods of production described in Japanese Patent No. 3,649,339 and U.S. Pat. No. 5,275,836. The production methods described in these documents do not steam raw unhusked rice as is but instead husk the raw unhusked rice and steam the brown rice obtained as a result of dehulling, so that the odor of the chaff does not seep into the endosperm and finished parboiled rice without the branny flavor is produced.

However, the prior art has the following problems. Specifically, in the prior art, when steam-boiling the raw material brown rice, a soaking process for increasing the moisture content of the brown rice to approximately 30% by weight is required prior to the steam-boiling. The soaking process is a process of immersing the raw material brown rice in a soaking tank containing hot water at a temperature of approximately 60° C. for approximately 60 minutes, for example. As a result, a large amount of water is required for the soaking tank, and at the same time waste water treatment equipment is required to discharge the water after use. Consequently, running costs increase due to the use of large amounts of hot water in the soaking process, and equipment costs increase due to the need for the waste water treatment equipment.

### SUMMARY OF THE INVENTION

The present invention provides a method of producing parboiled rice that does not require a process for increasing the moisture content of the raw material brown rice using large amounts of hot water such as a soaking process and thus does not require waste water treatment equipment, and that moreover increases amounts of functional ingredients contained in the parboiled rice thus produced.

The method of the present invention is for producing parboiled rice from brown rice. According to one aspect of the present invention, the method comprises the steps of: partially milling grains of the brown rice; wetting the partially milled grains by forcing the grains into moist air; tempering moisture of the wetted grains; steam-boiling the tempered grains with steam at normal pressure; steam-boiling the grains processed by the normal pressure steam-boiling step with pressurized steam; cooling the grains processed by the pressurized steam-boiling step to reduce heat on the grains; finish-milling the grains processed by the cooling step; and drying the finish-milled grains to obtain grains of the parboiled rice. Parboiled rice of the present invention are produced from brown rice by the above method wherein amounts of γ-aminobutyric acid contained in the grains of parboiled rice are enriched (increased).

The grains may be forced into moist air having temperature not less than 50° C. and humidity not less than 90% in the wetting step.

The grains maybe wetted until the grains have moisture in a range between 16% and 19% by weight in the wetting step.

The grains may be tempered with temperature of the grains maintained at or above 50° C. in the tempering step.

The grains may be partially milled with germ remaining in the partially milling step.

According to another aspect of the present invention, the method comprises the steps of: partially milling grains of the brown rice; wetting the partially milled grains by mist of water; tempering moisture of the wetted grains; steam-boiling the tempered grains with steam at normal pressure; steam-boiling the grains processed by the normal pressure steam-boiling step with pressurized steam; cooling the grains processed by the pressurized steam-boiling step to reduce heat on the grains; finish-milling the grains processed by the cooling step; and drying the finish-milled grains to obtain grains of the parboiled rice. Parboiled rice are produced by the method comprising the above steps.

In this case, the grains may be wetted at a moisture increase rate between 0.5% and 0.8% by weight per hour in the wetting step, and the wetting step and the moisture-tempering step may be repeatedly performed alternatively until the grains have moisture in a range between 17% and 19% by weight. The grains may be partially milled with germ remaining in the partially milling step.

According to the parboiled rice production method of the present invention, in the partially milling step the raw material brown rice is partially milled to make it easier for water to seep into the interior of the rice grains (the endosperm), after which the rice grains are conveyed to the later stages of steam-boiling under normal pressure and then steam-boiling with pressurized steam, which enables the parboiled rice to be gelatinized while its moisture content is raised.

Therefore, in the parboiled rice production method of the present invention there is no need for a soaking step of soaking the rice grains, and thus no need for the large amounts of hot water used in the soaking step. As a result, both the initial cost and the running cost of the equipment that would be needed for heating the water used in soaking can be reduced. Further, since there is also no need to provide the waste water treatment equipment indispensable to the soaking step, the initial cost and the running cost of the equipment that would be needed for such waste water treatment equipment can be reduced

Moreover, in the parboiled rice production method of the present invention, the partial milling step has the effect not only of improving the water absorption properties of the rice grains but of leaving the germ in the rice grain, and as a result, the GABA (γ-aminobutyric acid) nutrient component of the partially milled rice grains can be enriched by carrying out the wetting step and the moisture-tempering step. Therefore the parboiled rice produced by the production method of the present invention with its enriched GABA nutritional ingredient content can provide more added value than the conventional product.

### BRIEF DESCRIPTION OF THE DRAWINGS

FIG. 1 is a flow chart illustrating a method of producing parboiled rice according to a first embodiment of the present invention;

FIG. 2 is a vertical sectional view of a vertical abrasive-type milling machine;

FIG. 3 is a schematic view of a forced-air wetting apparatus and a moisture-tempering apparatus;

FIG. 4 is a partial vertical section view of the forced-air wetting apparatus;

FIG. 5 is a horizontal sectional view of the forced-air wetting apparatus;

FIG. 6 is a vertical sectional view of a normal pressure steam-boiling apparatus and a pressurized steam-boiling apparatus;

FIG. 7 is a vertical sectional view of a cooling apparatus;

FIG. 8 is a vertical sectional view of a circulation-type grain dryer;

FIG. 9 is a flow chart illustrating a method of producing parboiled rice according to a second embodiment of the present invention; and

FIG. 10 is a schematic view of a wetting apparatus and a tempering apparatus used in the second embodiment of the present invention.

### DETAILED DESCRIPTION

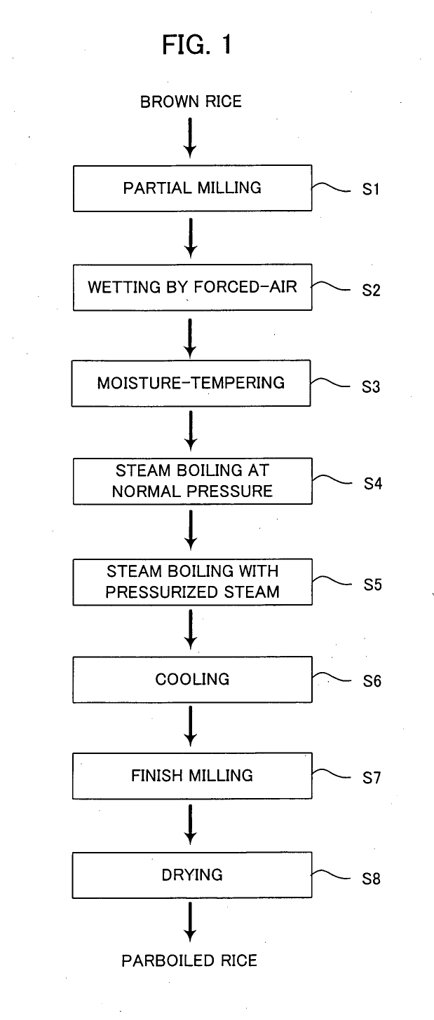

A description is now given of a first embodiment of the present invention, with reference to the flow chart illustrating a method of producing parboiled rice shown in FIG. 1.

Step S1 (Partial Milling Process)

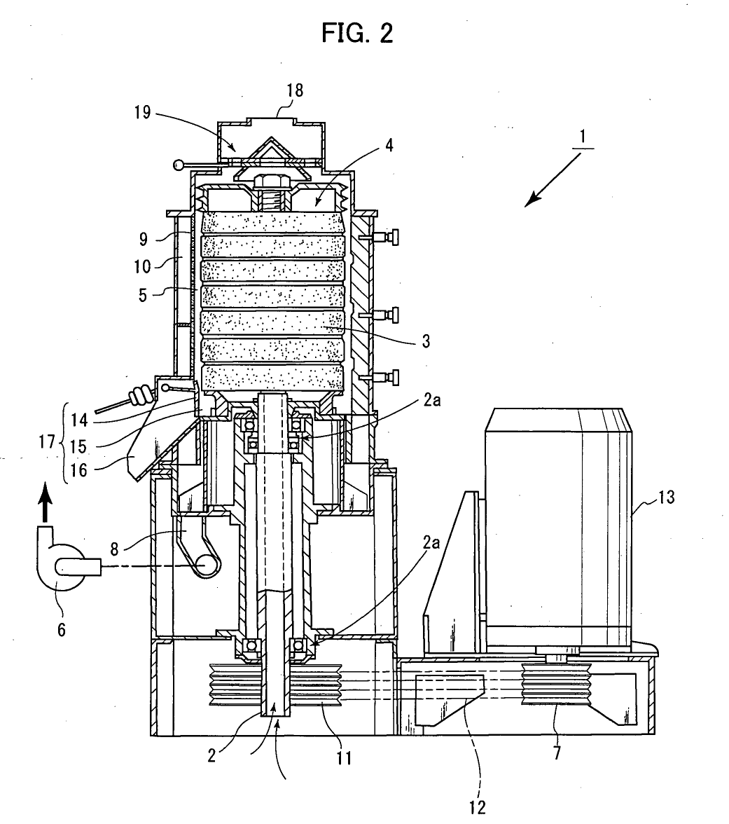

In the partial milling process, brown rice as raw material is partially milled. The brown rice is prepared by husking unhusked rice (either a long-grain variety or a medium-grain variety). In the partially milling process, a known vertical abrasive-type milling machine 1 shown in FIG. 2 for example is used. A structure of the vertical abrasive-type milling machine 1 comprises a milling roll assembly 4 comprised of a whetstone roll 3 axially mounted on a vertically disposed rotary shaft 2, a perforated cylindrical screen 9 mounted around an outer circumference of the milling roll assembly 4 across a predetermined interval gap (milling chamber) 5, and a removed-bran collecting chamber 10 disposed around an outer circumference of the perforated screen 9. The rotary shaft 2 is supported by shaft bearings 2a provided at upper and lower arbitrary positions along the rotary shaft 9, with a lower end of the rotary shaft 9 coupled to a pulley 7 on an output side of a motor 13 via an axially mounted pulley 11 and a motive force transmission belt 12 so as to rotate freely. Further, a product discharge part 17 is built into a lower end of the milling chamber 5, and is comprised of a resistance lid 14, a product discharge outlet 15, and a product discharge path 16.

An upper end of the milling chamber 5 communicates with a raw material supply port 18 disposed above the upper end of the milling chamber 5. A raw material supply adjustment unit 19 is provided on the raw material supply port 18. It should be noted that a lower end of the bran collecting chamber 10 communicates with a pipe 8 and an exhaust fan 6, and is configured to suck up and discharge bran to the outside.

The partial milling process (Step S1) involves partially milling the raw material brown rice to remove between 1% and 5% of the total weight of the rice grain using the vertical abrasive-type milling machine 1 described above. Partially milling the raw material brown rice has the effect of making it easier for the rice grains to absorb moisture into the endosperm portion in the process of wetting the brown rice later on. Also, the germ still remains in rice grains that are partially milled to remove between 1% and 5% of the total weight of the rice grain, which contributes to enriching the GABA (γ-aminobutyric acid) nutrient component of the rice grains in a later process.

Step S2 (Forced-air Wetting Process) and Step S3 (Moisture-Tempering Process)

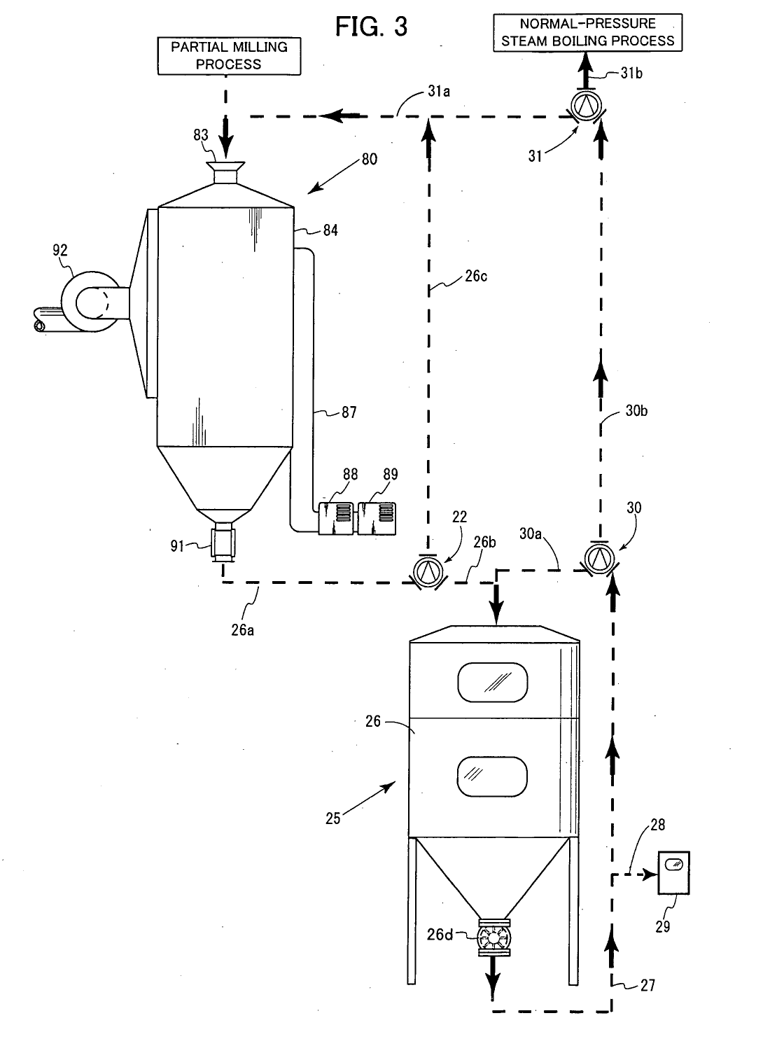

In the forced-air wetting process, the partially milled brown rice, which is simply referred to as partially milled rice, processed by the partial milling process described above is forced into moist air to wet the brown rice. In the subsequent moisture-tempering process, the wetted brown rice is held in a tank while being circulated, enriching the GABA component of the rice grains. An apparatus having the same structure as a known circulating type grain dryer, for example, can be used as the apparatus used in the wetting process. In the present invention, a forced-air type wetting apparatus 80 shown in FIGS. 3, 4, and 5 is used. By contrast, a known moisture-tempering apparatus 25 shown in FIG. 3 is used as the apparatus for the moisture-tempering process.

The forced-air type wetting apparatus 80 is comprised of an approximately square pillar-shaped tank 84, an intake unit 85, and an exhaust unit 86. A supply port 83 for supplying raw material is provided on a top part of the tank 84 and a feed valve 91 is provided on a discharge outlet in a bottom part of the tank 84. Raw material supplied from the supply port 83 flows down through the interior of the tank 84 and is discharged from the feed valve 91.

The raw material discharged from the feed valve 91 passes through a flow path 26a and a flow path switching valve 22 and is sent to a circulation part 26c or a flow path 26b. The raw material sent to the circulation part 26c passes through a flow path 31a and is sent to the supply port 83, where it is once again moistened by the forced-air type wetting apparatus 80. A known bucket-type elevator or a pressurized air conveyer-type air conveyer apparatus is used for the circulation part 26c. Arbitrary sample extraction means for extracting a sample of the raw material (for example, a sample extraction path, not shown) is provided on the circulation part 26c circulation path. A known grain moisture meter is connected to the sample extraction means so that the amount of moisture (water) in the raw material passing through the circulation path is constantly being measured. The wetting of the raw material continues and the raw material is circulated in the forced-air type wetting apparatus 80 until the moisture content (water) of the raw material reaches a predetermined range. Then, when the moisture content (water) of the raw material reaches a predetermined range, the flow path switching valve 22 is switched and the raw material is sent to the moisture-tempering apparatus 25.

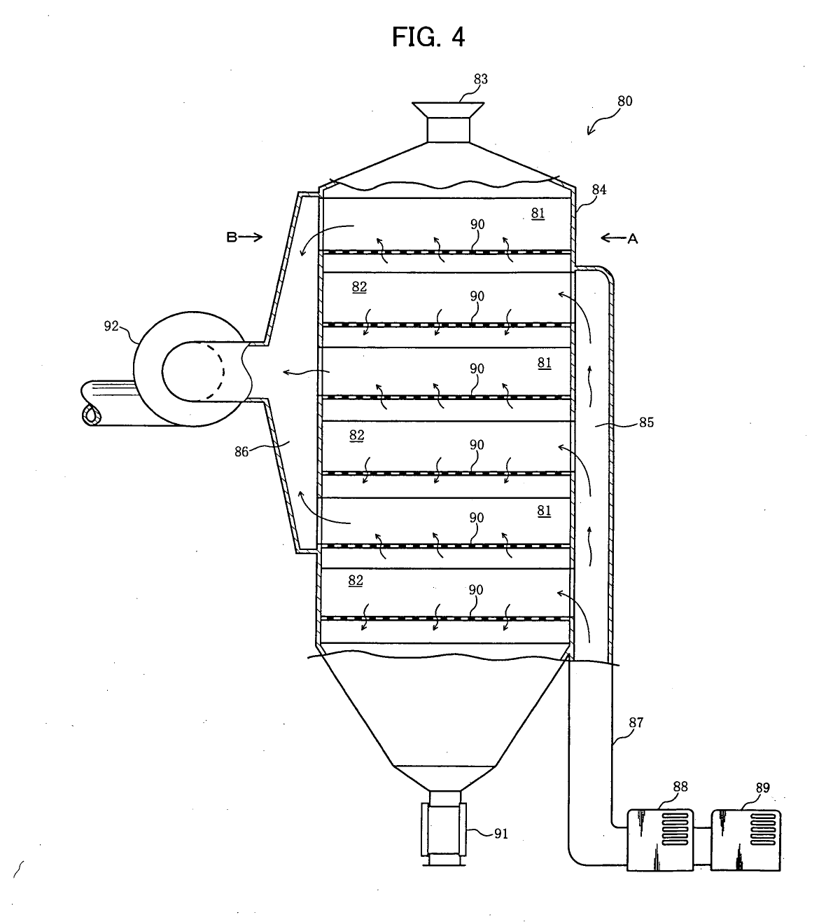

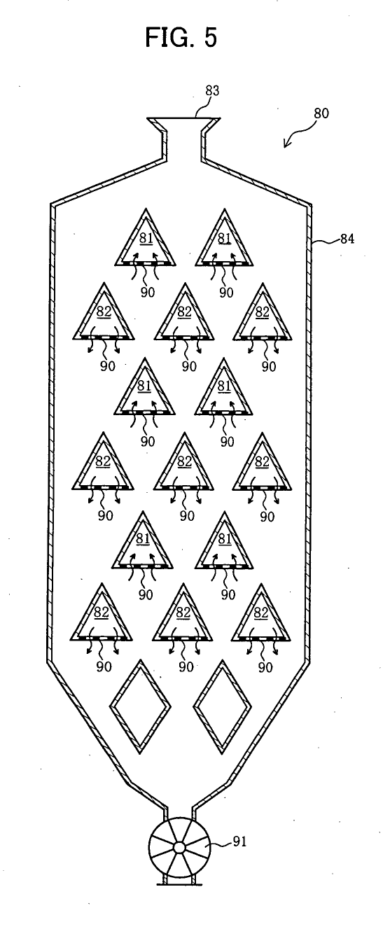

As shown in FIG. 4, a plurality of intake louvers 82 and exhaust louvers 81 are disposed horizontally across the interior of the tank 84. FIG. 5 is a schematic horizontal sectional view of the tank 84. As shown in FIG. 5 in cross-section the intake louvers 82 and the exhaust louvers 81 are formed in the shape of chevrons, on a bottom face of each of which is provided a perforated plate 90. The intake louvers 82 are communicably connected to the intake unit 85 provided on one lateral side (side A in FIG. 4) of the forced-air type wetting apparatus 80, and the exhaust louvers 81 are communicably connected to the exhaust unit 86 provided on another lateral side (side B in FIG. 4) of the forced-air type wetting apparatus 80. The intake unit 85 is connected to an intake pipe 87. The intake pipe 87 is connected to a humidifying apparatus 88 and to a hot air generator 89. The exhaust unit 86 is connected to an exhaust fan 92.

A description is now given of the humidifying apparatus 88 and the hot air generator 89 while referring to FIG. 3. Although an ordinary vaporizing-type apparatus is used as the humidifying apparatus 88 in the present embodiment, alternatively a steam-type apparatus or an apparatus based on some other type of humidifying system may be used. A burner commonly used in grain dryers can be used for the hot air generator 89. When wetting the raw material (the partially milled rice), the hot air generated by the hot air generator 89 is passed through the humidifying apparatus 88 by the suction effect of the exhaust fan 92 and becomes humid air (moist air), which passes through the intake pipe 87, the intake unit 85, the intake louvers 82, the interior of the tank 84, the exhaust louvers 81, and the exhaust unit 86, and is exhausted to the exterior of the apparatus from the exhaust fan 92. A temperature and humidity sensor, not shown, which detects temperature and humidity of the moist air, is provided on the intake unit 85.

The set humidity and temperature of the humid air (moist air) that passes through the interior of the tank 84 during wetting are determined on the basis of the amount of raw material involved. The heating amount level of the hot air generator 89 is varied based on the humidity and temperature detected by the temperature and humidity of the moist air so that the humidity and temperature of the moist air respectively become the set humidity and temperature described above.

In addition, the amount of humid air (moist air) that passes through the interior of the tank 84 per unit amount of rice to be processed is in the range of 0.2-0.4 m³/second per ton, preferably 0.25-0.35 m³/second per ton, more preferably still 0.28-0.32 m³/second per ton. The temperature of the moist air is at least 50° C., preferably 50° C.-75° C., more preferably still 60° C.-70° C. The humidity of the moist air is at least 90%, preferably at least 95%.

Even if the temperature of the moist air is less than 50° C. it is still possible to increase the amount of functional ingredients such as γ-aminobutyric acid contained in the grain. However, the lower the temperature of the moist air, the longer the time required for tempering to increase the above-described functional ingredients. Moreover, whereas old rice is not much affected, in the case of processing new rice it is difficult to increase the above-described functional ingredients adequately if the temperature of the moist air is less than 50° C.

It should be noted that an intake fan can be connected to the hot air generator 89, in a structure that circulates the exhaust from the exhaust fan 92. In addition, in the present invention, when a hot air generator burner that uses kerosene as fuel is used as the hot air generator 89, there is the possibility that the smell attaches to the raw material. Therefore, it is preferable to use a hot air heater or a heat exchanger or the like.

The above-described moisture-tempering apparatus 25 comprises a cylindrical tank 26. The flow path 26b is connected to a top supply port of the tank 26. The flow path 26b is connected to the feed valve 91, which is the exhaust unit of the forced-air type wetting apparatus 80 described above, via the flow path 26a and the flow path switching valve 22. By contrast, a feed valve 26d is provided on a bottom discharge outlet of the tank 26. In addition, the moisture-tempering apparatus 25 also comprises a circulation part 27 for circulating the partially milled rice discharged from the feed valve 26d inside the tank 26. A known bucket-type elevator or a pressurized air conveyer-type air conveyer apparatus is used for the circulation part 27. Arbitrary sample extraction means for extracting a sample of the raw material (for example, a sample extraction path, not shown) 28 is provided on the circulation path of the circulation part 26c. A known grain moisture meter 29 is connected to the sample extraction means so that the amount of moisture (water) in the raw material passing through the circulation path is constantly being measured.

In addition, a flow path switching valve 30 is provided on the discharge side of the circulation part 27, making it possible to switch between a flow path 30a that circulates to the tank 26 and a flow path 30b that leads to the forced-air type wetting apparatus 80 or to a next process (steam-boiling the water-tempered rice grains at normal pressure/Step S4). A flow path switching valve 31 is provided on a downstream side of the flow path 30b, making it possible to switch between the flow path 31a circulating to the supply port 83 of the forced-air type wetting apparatus 80 and a flow path 31b leading to the next process (steam-boiling the water-tempered rice grains at normal pressure/Step S4). It should be noted that the above-described flow paths use, for example, pipes disposed in a downwardly slanting state.

The purpose of the moisture-tempering process of the present invention is to increase the amount of γ-aminobutyric acid contained in the rice grains. Accordingly, it is preferable that the tank 26 be equipped with a thermal insulation device or a heating apparatus so as to maintain the temperature of the grains of the partially milled rice sent from the forced-air type wetting apparatus 80 at approximately 60° C.-75° C. It should be noted that partially milled rice whose grain temperature has cooled may be sent to the forced-air type wetting apparatus 80 and reheated.

The forced-air wetting process (Step S2) involves, first, successively wetting the partially milled rice supplied to the forced-air type wetting apparatus 80 in units of single lots from the supply port 83 from the previous process (Step S1/partial milling process) using the moist air supplied from the intake louvers 82. This wetting is carried out uniformly without exception by exposing the partially milled rice grains falling through the interior of the tank 84 to the moist air passing through the interior of the tank 84.

The moisture content (water) of the raw material (partially milled rice) moistened by the humid air while falling through the inside of the tank 84 is measured by the grain moisture meter of the sample extraction means provided on the circulation part 26c. The raw material is continuously circulated and moistened by the forced-air type wetting apparatus 80 until the measured water readings are within a predetermined range. The final moisture content of the raw material after wetting in the forced-air wetting process is set as appropriate according to the type of brown rice to be processed, based on results obtained by experiment, i.e., generally in the range of 16.0% to 20.0%, or 16.0% to 19.0%, or 17.0% to 18.5%.

It should be noted that it is preferable that wetting be conducted at a rate that does not cause cracks to appear in the rice grains due to wetting. Accordingly, it is necessary that the rate of wetting be leisurely, for example, preferably the wetting is performed at a moisture increase rate in the range between 0.3% by weight per hour and 0.8% by weight per hour.

Next, in the moisture-tempering process (Step S3), one lot of partially milled rice moistened in the above-described forced-air wetting process (Step S2) is supplied to the tank 26 of the moisture-tempering apparatus 25 and accumulates there, where it is successively circulated by the driving of the feed valve 26d and the circulation part 27 and tempered. During tempering, a sample of the wetted partially milled rice is sent to the grain moisture meter 29 by the above-described sample extraction means 28, and the moisture content of the brown rice sample is measured.

In the moisture-tempering process, the partially milled rice moistened until it has a moisture content in the range of 16% to 19% is tempered while being circulated for 1 hour to 5 hours in a state in which the temperature of the rice (that is, the temperature of the rice grains) is maintained at at least 50° C., preferably in the range of 50° C. to 70° C. The purpose (or effect) of doing so is to increase the γ-aminobutyric acid (GABA) nutritional component of the partially milled rice. Accordingly, during tempering the moisture content of the partially milled rice declines, and in a case in which the measured moisture content of the brown rice sample described above is not within the range of 16% to 19%, the flow path switching valves 30 and 31 are switched and the partially milled rice inside the tank 26 is returned to the forced-air type wetting apparatus 80 and re-moistened. The re-moistened partially milled rice is once more supplied to the moisture-tempering apparatus 25 and circulated, it is checked whether or not the moisture content (water) of the partially milled rice is within the range of 16% to 19% using the grain moisture meter 29, and tempering is carried out in the moisture-tempering apparatus 25 if the moisture content is within the above-described range.

It should be noted that, in the moisture-tempering process, the time for tempering the partially milled rice that is the raw material can be easily altered, and therefore may be varied as convenient depending on the variety of brown rice to be processed and the amount by which the γ-aminobutyric acid to be increased. The above-described grain temperature may be adjusted so that it is at least 50° C., preferably 50° C.-75° C., more preferably still 60° C.-70° C.

However, in the Asian region, since there are few facilities for drying and storing unhusked rice after harvest, the moisture content of unhusked rice raw material varies greatly. Nevertheless, with the present moisture-tempering process and the above-described forced-air wetting process, the moisture content of the unhusked rice raw material can be made uniform, which is useful in producing parboiled rice of a consistent quality. This is one more purpose (effect).

Once the tempering process in the moisture-tempering process is finished, the flow path switching valves 30 and 31 are switched and the partially milled rice having completed the tempering process is conveyed via the flow path 31b to the next process (steam-boiling the water-tempered, partially milled rice at normal pressure/Step S4).

Step S4 (Normal Pressure Steam-Boiling Process)

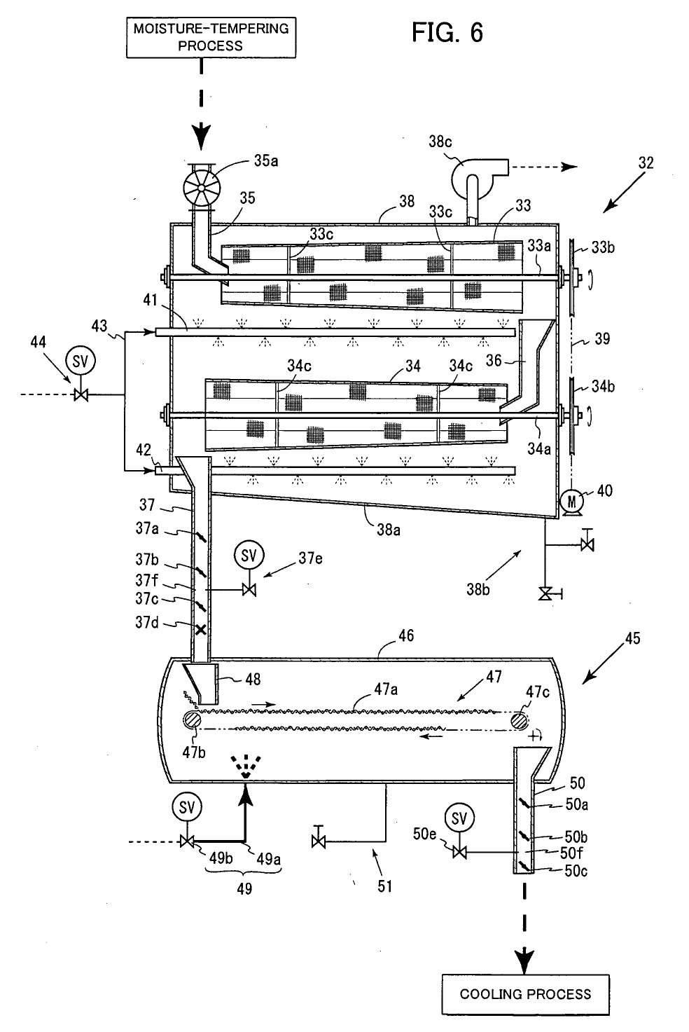

In the process of steam boiling at normal pressure, the water-tempered, partially milled rice is heated with steam at normal pressure (atmospheric pressure). A normal pressure steam-boiling apparatus 32 used in the present steam-boiling at normal pressure process is shown in FIG. 6. The normal pressure steam-boiling apparatus 32 disposes polygonal prism-shaped rotary drums 33, 34 composed of perforated walls horizontally one above the other within a sealed machine casing 38. The rotary drum 33 is disposed horizontally at an upper level, slanting downwardly from a supply opening side at one end to a discharge opening side at another end, so that the raw material flows downward. A discharge side of a raw material supply pipe 35 is inserted into the supply opening side at the one end of the rotary drum 33, and the discharge opening side at the other end leads to a downward transport pipe 36 for transporting and supplying the raw material discharged from the rotary drum 33 to a supply opening side at one end of the rotary drum 34 disposed horizontally below the rotary drum 33 at a lower level.

Like the rotary drum 33, the rotary drum 34 is slanted downwardly from a supply opening side at one end to a discharge opening side at another end, with a discharge side of the downward transport pipe 36 inserted into the supply opening side at the one end of the rotary drum 34 and the discharge opening side at the other end of the rotary drum 34 leading to a downward transport pipe 37 that transports and supplies raw material to the next process (the pressurized steam-boiling process/Step S5. The rotary drums 33, 34 are respectively coupled to rotary shafts 33a, 34a disposed horizontally through the interior center of each drum by coupling plates 33c, 34c, and at the same time are rotatably supported by bearings provided in a wall of the machine casing 38. One end of each of the rotary shafts 33a, 33b is coupled to a motor 40 via pulleys 33b, 34b and a motive force transmission belt 39.

Steam spray pipes 41, 42 extending the entire length of the rotary drums 33, 34 are disposed horizontally below the rotary drums 33, 34, respectively, with steam supply source sides of the steam spray pipes 41, 42 connected to a steam supply source, not shown, via a steam pipe 43 and a shut-off valve 44. A floor part 38a of the machine casing 38 slants downwardly toward one end, and a drain part 38b is provided at the bottom of the slanted port for draining steam accumulated as drops of water in the normal pressure steam-boiling apparatus 32. It should be noted that a feed valve 35a is provided on a top supply side of the raw material supply pipe 35 described above.

There is no particular limitation on the rpm of the above-described rotary drums 33, 34 the rotation speed of which may be set as appropriate, such that the time that the raw material (partially milled rice) spends passing through the interiors of the rotary drums 33, 34 is within a range of from 10 seconds to 300 seconds so that the rice grains do not crack. In addition, the amount of steam supplied from the steam spray pipe 41 to fill the interior of the machine casing 38 is set as appropriate so that the rice grains do not crack.

A description is now given of the operation of the normal pressure steam-boiling process (Step S4). Specifically, the present process of steam-boiling at normal pressure using the normal pressure steam-boiling apparatus 32 causes the normal pressure steam-boiling apparatus 32 to fill the interior of the machine casing 38 with steam supplied from the steam spray pipe 41 at a temperature of approximately 100° C. as the rotary drums 33, 34 rotate so that single lots of partially milled rice tempered in the previous process are successively supplied to the supply opening side at the one end of the rotary drum 33 through the feed valve 35a and the raw material supply pipe 35.

The partially milled rice supplied to the rotary drum 33 is then heated by the steam at normal pressure (maximum vapor tension) and the air between the grains of rice is driven out by the steam and is replaced by the steam which thus fills the space once occupied by air, and the rice flows downward toward the discharge opening at the other end while being agitated by the rotation of the rotary drum 33. At this time, the air between the grains of rice is discharged from an air exhaust unit comprised of an exhaust pipe and an exhaust fan provided on the top of the machine casing 38. The partially milled rice discharged from the discharge opening side at the other end of the rotary drum 33 is supplied through the downward transport pipe 36 to the interior of the rotary drum 34 from the supply opening side at the one end of the rotary drum 34, after which the partially milled rice is discharged from the discharge opening side at the other end of the rotary drum 34 while being agitated and transported while being exposed to the effects of heating and the effects of filling the space between the grains of rice with steam inside the rotary drum 34 the same as with the rotary drum 33. As a result, the partially milled rice discharged after undergoing processing in the normal pressure steam-boiling apparatus 32 is heated to approximately 100° C. without cracking, and further, the space between the grains is filled with steam and preparatory processing has been carried out for the purpose of carrying out gelatinization in the next process (the pressurized steam-boiling process) with good quality.

Moreover, because steam is used in the present process of steam-boiling at normal pressure, the amount of water discharged from the drain part 38b is small.

Step S5 (Pressurized Steam-boiling Process)

In the process of steam-boiling using pressurized steam, the partially milled rice having completed the heat treatment described above is gelatinized.

A pressurized steam-boiling apparatus 45 used in the pressurized steam-boiling process is shown in FIG. 6. The pressurized steam-boiling apparatus 45 has a belt conveyer 47 built into the interior of a sealed machine casing 46. The belt conveyer 47 is comprised of a net-like endless conveyance belt 47a, and a driving roller 47b and a driven roller 47c around which the endless conveyance belt 47a is stretched. A pressurized steam supply part 49 for supplying pressurized steam into the sealed space formed by the machine casing 46 is disposed on a floor of the machine casing 46. The pressurized steam supply part 49 is comprised of a pressurized steam supply source, not shown, that connects to a supply port, not shown, provided in the floor of the machine casing 46 through a steam pipe 49a, and a shut-off valve 49b provided at an intermediate location on the steam pipe 49a.

A slanted chute 48 that supplies raw material to the belt conveyer 47 is provided at a conveyance starting end of the belt conveyer 47. An upstream end of the slanted chute 48 communicates with the discharge side of the above-described downward transport pipe 37 through which raw material discharged from the previous process is transported.

Multiple valves are built into an interior of the downward transport pipe 37 for preventing the pressurized steam inside the machine casing 46 from passing through and escaping from the downward transport pipe 37 when the raw material is supplied to the pressurized steam-boiling apparatus 45. As the above-described plurality of valves inside the above-described downward transport pipe 37 there are, at arbitrary intervals in order from the top, an impact absorption damper 37a for absorbing the impact of the fall of the raw material; an upper butterfly valve 37b; a lower butterfly valve 37c; and a loosening plate 37d for loosening clumps of raw material (pressure-cooked partially milled rice) supplied from the previous process. In addition, a bleeder valve 37e is provided in a gap 37f between the upper butterfly valve 37b and the lower butterfly valve 37c.

When the raw material is supplied to the pressurized steam-boiling apparatus 45 through the downward transport pipe 37, first, the above-described upper butterfly valve 47b and the lower butterfly valve 37c are both closed and the pressure (pressurized steam) in the gap 37f is bled from the bleeder valve 37e. Next, the upper butterfly valve 37b is opened and the raw material is supplied from the top supply side into the gap 37f while the flow volume is adjusted by an extent of the opening of the above-described impact absorption damper 37a. Then, when the raw material in the gap 37f reaches a certain accumulation, the bleeder valve 37e is closed and the upper butterfly valve 37b is closed, after which the lower butterfly valve 37c is opened and the raw material falls by its own weight and is supplied to the pressurized steam-boiling apparatus 45 (the slanted chute 48) through the loosening plate 37b. The foregoing procedure is repeated until one lot of raw material is successively supplied to the interior of the pressurized steam-boiling apparatus 45.

A downward transport pipe 50 for discharging the partially milled rice having finished gelatinization in the pressurized steam-boiling apparatus 45 to the exterior of the machine casing 46 is provided at a conveyance ending end of the belt conveyer 47. Multiple valves are built into an interior of the downward transport pipe 50 for preventing the pressurized steam inside the machine casing 46 from passing through and escaping to the outside from the downward transport pipe 50 when discharging the partially milled rice having finished gelatinization in the pressurized steam-boiling apparatus 45. Substantially as with the downward transport pipe 37, the downward transport pipe 50 has as the above-described plurality of valves inside the above-described downward transport pipe 50, at arbitrary intervals in order from the top, an impact absorption damper 50a for absorbing the impact of the fall of the partially milled rice having finished gelatinization; an upper butterfly valve 50b; and a lower butterfly valve 50c. In addition, a bleeder valve 50e is provided in a gap 50f between the upper butterfly valve 50b and the lower butterfly valve 50c of the downward transport pipe 50. It should be noted that a drain part 51 is provided in the floor of the machine casing 46 for draining steam accumulated as drops of water in the pressurized steam-boiling apparatus 45.

When the partially milled rice having finished gelatinization is discharged from the pressurized steam-boiling apparatus 45 through the downward transport pipe 50, first, the above-described upper butterfly valve 50b and the lower butterfly valve 50c are both closed and the pressure (pressurized steam) in the gap 50f is bled from the bleeder valve 50e. Next, the upper butterfly valve 50b is opened and partially milled rice having finished gelatinization is supplied into the gap 50f while the flow volume is adjusted by an extent of the opening of the above-described impact absorption damper 50a. Then, when the brown rice in the gap 50f reaches a certain accumulation, the bleeder valve 50e is closed and the upper butterfly valve 50b is closed, after which the lower butterfly valve 50c is opened and the partially milled rice having finished gelatinization falls by its own weight and is discharged. The foregoing procedure is repeated until one lot of partially milled rice having finished gelatinization is successively discharged to the exterior of the pressurized steam-boiling apparatus 45.

A description is now given of the operation of the present pressurized steam-boiling process (Step S5). Specifically, the interior of the pressurized steam-boiling apparatus 45 (the interior of the machine casing 46) is supplied and filled with pressurized steam from the pressurized steam supply part 49, raising the inside pressure to 0.2 MPa to 0.4 MPa, with the temperature of the steam set at approximately 145° C. In addition, the conveyance speed of the belt conveyer 47 is set to a convenient speed, such that a time from which the partially milled rice is supplied to a time at which the partially milled rice is discharged is in the range of 120 seconds to 1800 seconds. Under such set conditions is the partially milled rice, having finished preparatory processing in the previous process (steam-boiling at normal pressure, Step S4), that is, the partially milled rice that has been heated to approximately 100° C. and without cracking and moreover has been filled with steam (i.e., from which the air has been driven out), successively supplied to the belt conveyer 47 through the downward transport pipe 37 and the slanted chute 48.

The partially milled rice supplied to the belt conveyer 47 is conveyed by the belt conveyer 47 through the interior of the pressurized steam-boiling apparatus 45 and gelatinized while the moisture content of the rice grains is raised by the interior pressure and the pressurized steam so that at discharge the degree of gelatinization is 100%. At this point, the partially milled rice supplied to the pressurized steam-bioling process, because it has undergone the preparatory processing described above, has the space between the rice grains filled smoothly with pressurized steam, thus preventing unevenness in the gelatinization process from occurring and providing the advantage of improving the quality of the finished product. In addition, because it has already been heat-treated, the time required for approximately 100% gelatinization can be shortened, providing an advantage in terms of production efficiency of gelatinization as well. It should be noted that the pressure and the temperature of the pressurized steam may be set as appropriate while checking the gelatinization of the rice grains.

The gelatinized partially milled rice on the belt conveyer 47 is then discharged from the downward transport pipe 50 and transported and supplied to the next process (cooling process/Step S6).

In addition, because steam is used in the present pressurized steam-boiling process, the amount of water discharged from the drain part 51 is small.

Step S6 (Cooling Process)

The purpose of the cooling process is to remove heat from the surface of the partially milled rice having finished gelatinization in order to facilitate the next process (finish milling process/Step S7).

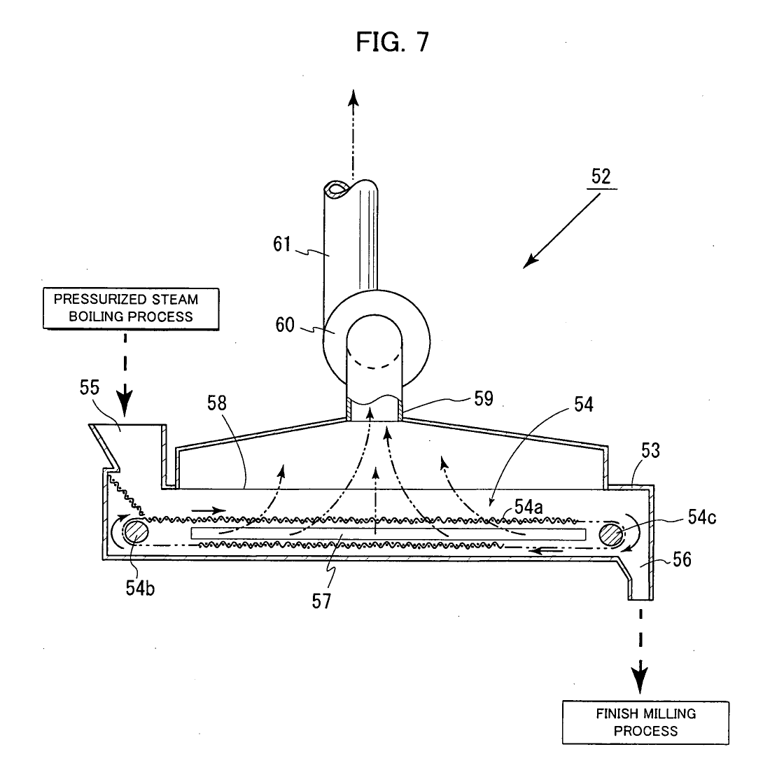

In the cooling process, a cooling apparatus 52 shown in FIG. 7 is used. The cooling apparatus 52 has a horizontally disposed belt conveyer 54 built into the interior of a machine casing 53. A supply part 55 for supplying partially milled rice transported and supplied from the previous process to the belt conveyer 54 is provided at a top part of one end of the machine casing 53, and a discharge part 56 for discharging expelled partially milled rice from the conveyance ending end of the belt conveyer 54 is provided at a bottom part of another end of the machine casing 53.

The belt conveyer 54 is comprised of a net-like endless conveyance belt 54a, and a driving roller 54b and a driven roller 54c around which the endless conveyance belt 54a is stretched. An air intake port 57 that is a long slot extending horizontally in a long direction of the belt conveyer 54 is formed in a front side of the machine casing 53. A suctional exhaust port 58 of a size corresponding to approximately the entire surface area of the conveyance surface of the belt conveyer 54 is provided in a top surface of the machine casing 53. The suctional exhaust port 58 is connected to an exhaust fan 60 and further an exhaust pipe 61 via a suction pipe 59.

A description is now given of the operation of the present cooling process (Step S6). Specifically, in the cooling process, the partially milled rice immediately after it has been gelatinized in the preceding process. (the pressurized steam-boiling process) is successively supplied to the conveyance starting end of the endless conveyance belt 54a from the supply part 55. The partially milled rice supplied to the endless conveyance belt 54a, while it is being conveyed by the belt conveyer 54, is exposed to outside air brought in through the outside air intake port 57 by the suction generated by the exhaust fan 60 and passing through the endless conveyance belt 54a from below, by which the heat from the surface of the rice grains is removed and the surface temperature thereof cooled. The partially milled rice with the lowered surface temperature is discharged from the discharge part 56. The discharged partially milled rice now has a moisture content in the range of 17% to 25%, and is conveyed to the next process (the finish milling process/Step S7). It should be noted that the conveyance speed of the belt conveyer 54 and the amount of suction generated by the exhaust fan 60 are set as appropriate while checking to make sure that the surface temperature of the discharged rice grains gets no higher than 60° C.

Step S7 (Finish Milling Process)

In the finish milling process (high moisture polishing process), the partially milled rice cooled in the previous process is subjected to finish milling. In the this finish milling process, the same sort of vertical abrasive-type milling machine 1 used in Step S1 (the partial milling process) (see FIG. 2). The construction of the vertical abrasive-type milling machine 1 is as described above.

A description is now given of the operation of the finish milling process (Step S7). When the partially milled rice from which the surface heat has been removed in the previous process (the cooling process) is successively supplied to the raw material supply port 18 of the vertical abrasive-type milling machine 1, the partially milled rice is milled in the milling chamber 5 and then discharged from the product discharge part 17. At this point, the partially milled rice raw material has had its heat removed in the previous process (the cooling process) and the slime has been removed from the surface of the rice grains, and therefore the milling proceeds smoothly. The discharged finished product white rice (parboiled rice) has a moisture content of approximately 18%, and is conveyed to the next process (drying process).

It should be noted that the speed of rotation of the milling roll assembly 4 and the resistance value of the product discharge part 17 are set as appropriate to ensure good milling quality and no brokens. In addition, in the present milling process, the milling conditions are varied as appropriate, and thus may be set so as to not produce completely polished rice but to produce partially polished rice, that is, rice with the germ (embryo-remaining rice).

Step S8 (Drying Process)

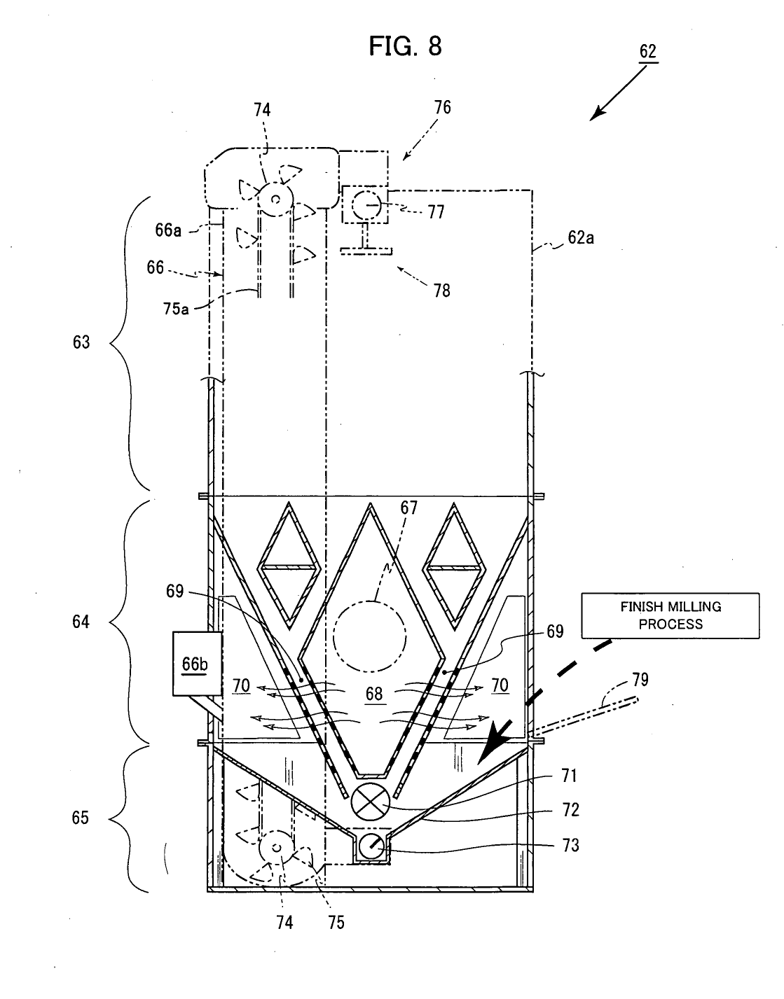

In the present drying process (Step S8), the finished product white rice (parboiled rice) discharged from the previous process is dried. The dryer used in the present drying process is, for example, a circulation-type cereal dryer 62 shown in FIG. 8. The circulation-type cereal dryer 62 may be a known apparatus, like that described, for example, in JP08-27134B, and is comprised of a dryer main unit 62a, which has, in order from the top stacked one atop the other, a holding part (tempering part) 63, a dryer part 64, and a discharge part 65, and an elevator 66 disposed alongside the dryer main unit 62a.

The dryer part 64 is comprised of a hot air drum 68; left and right grain flow passages 69 composed of perforated plates through which grains fall and through which hot air can pass; left and right exhaust air paths 70 through which hot air that has passed from the hot air drum 68 and through the grain flow passages 69 is discharged; and exhaust fans, not shown, that communicate with the exhaust air paths 70 and suction the hot air and discharge it to the outside of the dryer.

The discharge part 65 is comprised of a feed valve 71 provided on a bottom part of the grain flow passages 69; a funnel-shaped grain collector plate 72 disposed beneath the feed valve 71; and a lower conveyance screw 73 provided on a bottom part of the funnel-shaped grain collector plate 72 that conveys the grains to the conveyance starting end side of the elevator 66.

The elevator 66 has, inside a machine casing 66a, pulleys 74 provided at top and bottom parts of the elevator 66 and an endless bucket belt 75a stretched around the pulleys 74. A plurality of buckets 75 is attached to the bucket belt 75a. One of the pulleys 74 is connected to a motor, not shown, and becomes the driving side, so as to be able to convey and rotate the bucket belt 75a. A bottom of the machine casing 66a communicates with the conveyance ending end side of the lower conveyance screw 73, and a top of the machine casing 66a communicates with the conveyance starting end side of an upper conveyance part 76 to be described later. A grain moisture meter 66b is attached to a lateral side portion of the machine casing 66a so that the moisture content of the cereal being dried is automatically measured. The upper conveyance part 76 is provided on a top part of the holding part 63, and is comprised of an upper conveyance screw 77 and a splatter plate 78 disposed facing the interior of the holding part 63 at a location of the conveyance ending end side of the upper conveyance screw 77. It should be noted that a door 79 for supplying the material to be dried, which is the finished product white rice (parboiled rice), is provided in the machine casing wall of one of the exhaust air paths 70.

A description is now given of the operation of the present drying process (Step S8). First, when the door 79 is opened and one lot of the finished product white rice (parboiled rice) (moisture content approximately 18%) discharged from the previous process (the finish milling process, Step S7) is successively supplied, the above-described finished product white rice is conveyed to the holding part 63 via the lower conveyance screw 73, the elevator 66, and the upper conveyance screw 76, and accumulates in the holding part 63 (hereinafter this series of operations is referred to as a loading operation). Once the loading operation is finished, the door 79 is closed and the drying operation starts.

The drying operation uses the suction effect of the exhaust fans to pass the hot air generated by the burner 67 through the grains in the grain flow passages 69 (the finished product white rice). The feed valve 71 rotates discontinuously, feeding the grains of the grain flow passages 69 that are then circulated back to the holding part 63 via the lower conveyance screw 73, the elevator 66, and the upper conveyance screw 76 and tempered inside the holding part 63. Thus, the grains are circulated inside the dryer in the foregoing manner and dried evenly while being repeatedly exposed to hot air and tempered. Then, when the moisture content of the rice grains as measured by the grain moisture meter 66b declines for example to 13%, the drying operation is finished, a discharge operation is carried out, and the grains are discharged to the outside.

It should be noted that, following the present drying process (Step S8), as necessary a finish polishing process may be provided. This finish polishing process may be carried out using a known wet rice polisher, in which a small amount of mist water is added to the dry-processed grains (=finished product white rice (parboiled rice)) and the grains rubbed against each other to give them a gloss. Passing through such a finish polishing process improves the external appearance of the finished product.

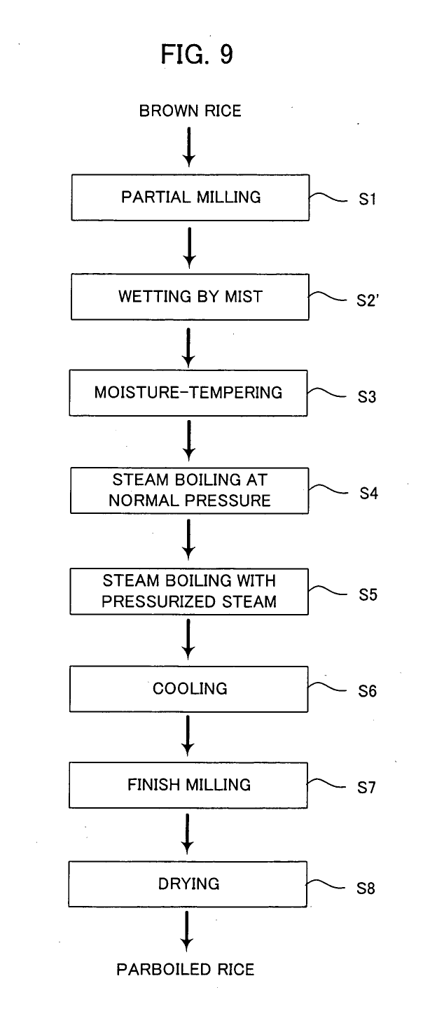

A description is now given of a second embodiment of the present invention, with reference to the parboiled rice production flow chart shown in FIG. 9.

In the second embodiment, the “forced-air wetting process” of Step S2 shown in FIG. 1 is replaced by “mist wetting process” of Step S2′. The remaining Steps S1 and S3-S8 are substantially the same as those shown in the production flow chart shown in FIG. 1.

Step S2′ (Mist Wetting Process)

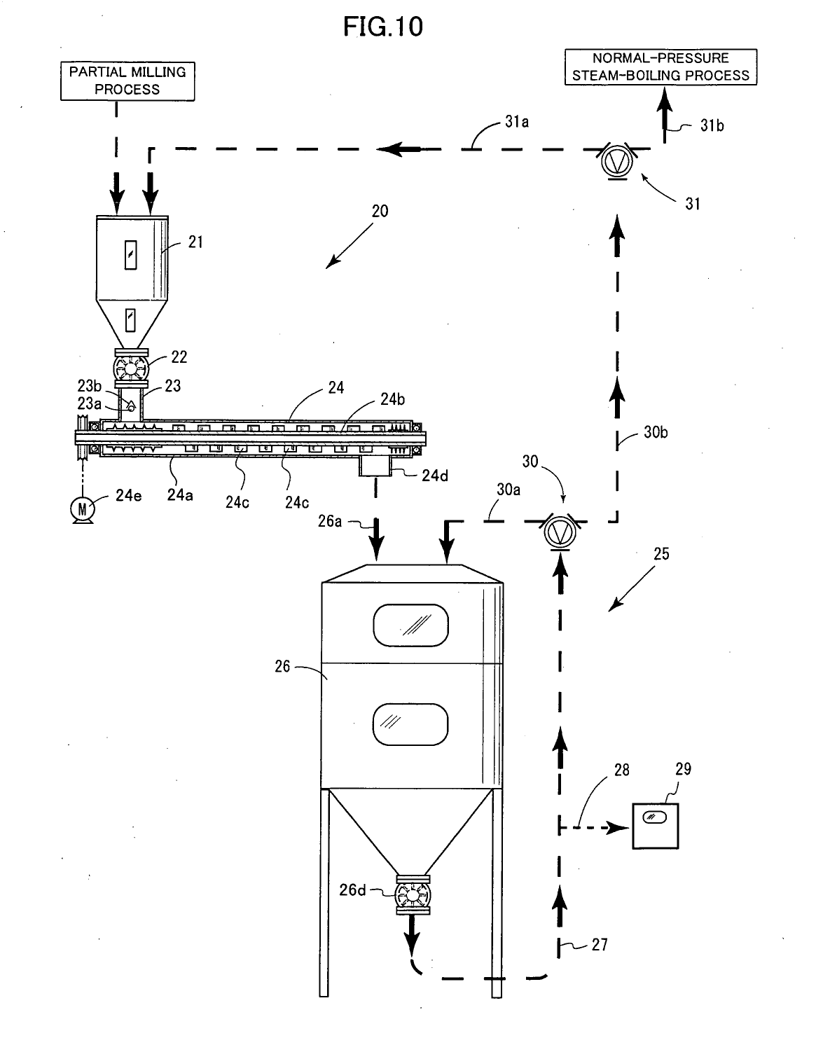

In the mist wetting process of the present embodiment, the partially milled brown rice obtained in the partial milling process is wetted by mist of water. In the following tempering process, the partially milled brown rice is held while being circulated in a tank at ordinary temperature, enriching the GABA component of the rice grains. A wetting apparatus 20 shown in FIG. 10, for example, can be used as the apparatus for the mist wetting process described herein.

The wetting apparatus 20 has a partially milled brown rice supply tank 21. The supply tank 21 leads to a supply pipe path 23 via a feed valve (rotary valve) 22, and further, connects to an upper part of one end of a supply side of an agitator transport unit 24. Inside the supply pipe path 23 are provided a misting nozzle 23a that sprays water in the form of a mist and a rice grain fall restrictor plate 23b disposed facing and above the misting nozzle 23a in the shape of an umbrella. The agitator transport unit 24 includes a horizontally disposed agitator sleeve 24a, to a supply side of which the supply pipe path 23 is connected and at a discharge side of which is provided a discharge part 24d. An agitator transport shaft 24b that rotates freely on shaft bearings is built into an interior of the agitator sleeve 24a. Agitator transport vanes 24c that impart both an agitation effect and a transport effect to the rice grains are disposed at equal intervals along the agitator transport shaft 24b in a long direction of the agitator transport shaft 24b. One end of the agitator transport shaft 24b is connected to a motor 24e via a pulley and a motive force transmission belt. It should be noted that the misting nozzle 23a is connected to a water pressure supply part, not shown, to enable the amount of mist water to be adjusted.

In the present embodiment, the top supply port of the tank 26 of the moisture-tempering apparatus 25 is connected to the flow path 26a that is connected to the discharge part 24d of the wetting apparatus 20, and a feed valve 26d is provided on the bottom discharge outlet thereof. In addition, a circulating flow part 27 for circulating the wetted partially milled brown rice discharged from the feed valve 26d inside the tank 26 is provided. A known bucket-type elevator or a pressurized air conveyer-type air conveyer apparatus is used for the circulation part 27. Arbitrary sample extraction means 28 for extracting a sample of the wetted partially milled brown rice (for example, a sample extraction path, not shown) is provided on a circulation path of the circulation part 27. A known grain moisture meter 29 is connected to the sample extraction means 28 so that the amount of moisture in the rice grains passing through the circulation path is constantly being measured.

In addition, a flow path switching valve 30 is provided on the discharge side of the circulation part 27, making it possible to switch between a flow path 30a that circulates to the tank 26 and a flow path 30b that leads to the wetting apparatus 20 or to a next process (steam-boiling the water-tempered rice grains at normal pressure/Step S4). A flow path switching valve 31 is provided on a downstream side of the flow path 30b, making it possible to switch between the flow path 31 a circulating to the supply tank of the wetting apparatus 20 and a flow path 31b leading to the next process (steam-boiling the water-tempered rice grains at normal pressure/Step S4). It should be noted that the above-described flow paths use, for example, pipes disposed in a downwardly slanting state.

A description is now given of the operation of the present mist wetting process (Step S2′). First, the partially milled brown rice is supplied to the wetting apparatus 20 in units of single lots (predetermined amounts) from the partial milling process of Step S1 and successively wetted. The wetting is carried out when the partially milled brown rice falls through the interior of the supply pipe path 23 is sprayed with mist water sprayed from the misting nozzle 23a and uniformly wetted. Subsequently, the partially milled brown rice is transported while being agitated by the agitator transport unit 24 in order to ensure that each rice grain is uniformly wetted, and discharged from the discharge part 24a. The amount of water added by misting from the misting nozzle 23a should be such that cracks do not appear in the rice grains due to water absorption. Accordingly, the speed of wetting must be leisurely, for example, preferably the wetting is performed at a moisture increase rate in the range between 0.5% by weight per hour and 0.8% by weight per hour. It should be noted that once wetting/rice grain discharge of one lot in the wetting apparatus 20 is finished, the wetting apparatus 20 is idled until the process of the next process (the tempering process/Step S3) is finished. Additionally, it should be noted that in the present mist wetting process no waste water is generated.

A description is now given of the operation of the moisture-tempering process (Step S3). Specifically, the one lot of partially milled brown rice wetted in the mist wetting process (Step S2) is supplied to the tank 26 of the moisture-tempering apparatus 25 where it accumulates, and is tempered by the action of the feed valve 26d and the circulation part 27. During circulation, samples of the wetted partially milled brown rice are extracted by the sample extraction means 28 and sent to the grain moisture meter 29, and the moisture content of the brown rice sample is measured.

In the present tempering process, the partially milled brown rice moistened until it has a moisture content in the range of 17% to 19% is tempered while being circulated for 8 hours to 16 hours under ordinary temperature ambient conditions. The purpose (or effect) of doing so is to increase the γ-aminobutyric acid (GABA) nutritional component of the brown rice. Accordingly, in a case in which the measured moisture content of the brown rice sample described above has not reached the range of 17% to 19%, the flow path switching valves 30 and 31 are switched and the partially milled brown rice inside the tank 26 is returned to the wetting apparatus 20 and re-wetted. The re-wetted partially milled brown rice is once more supplied to the tempering apparatus 25 and circulated and it is checked whether or not the moisture content (water) of the partially milled brown rice is within the range of 17% to 19% using the grain moisture meter 29. If the moisture content is within the above-described range the partially milled brown rice is circulated for the time period described above and tempered in the tempering apparatus 25. By contrast, if the moisture content is not within the above-described range, the partially milled brown rice is to the wetting apparatus 20 and re-wetted as described above.

The parboiled rice produced through the processes described above has an increased γ-aminobutyric acid (GABA) component, and therefore is rich in nutritional ingredients, and since no cracks appear it has a superior external appearance. In addition, in terms of production equipment as well, the present invention uses steam and thus the amount of waste water is small, and accordingly has the advantage that waste water treatment equipment required for large-scale waste water processing is unnecessary.

Moreover, the parboiled rice produced by the production method of the present invention, with its increased content of functional ingredients such as γ-aminobutyric acid, only increases the content of functional ingredients such as γ-aminobutyric acid in the grains; its other qualities remain the same as parboiled rice dried by known methods. Therefore, the parboiled rice produced by the production method of the present invention can be handled like ordinary cereals.

What is claimed is:

1. A method of producing parboiled rice from brown rice, comprising the steps of:
partially milling grains of the brown rice;
wetting the partially milled grains by forcing the grains into moist air;
tempering moisture of the wetted grains;
steam-boiling the tempered grains with steam at normal pressure;
steam-boiling the grains processed by said normal pressure steam-boiling step with pressurized steam;
cooling the grains processed by said pressurized steam-boiling step to reduce heat on the grains;
finish-milling the grains processed by said cooling step; and
drying the finish-milled grains to obtain grains of the parboiled rice.

2. A method of producing parboiled rice according to claim 1, wherein the grains are forced into moist air having temperature not less than 50° C. and humidity not less than 90% in said wetting step.

3. A method of producing parboiled rice according to claim 1, wherein the grains are wetted until the grains have moisture in a range between 16% and 19% by weight in said wetting step.

4. A method of producing parboiled rice according to claim 1, wherein the grains are tempered with temperature of the grains maintained at or above 50° C. in said moisture-tempering step.

5. A method of producing parboiled rice according to claim 1, wherein the grains are partially milled with germ remaining in said partially milling step.

6. Parboiled rice produced from brown rice by a method comprising the steps of:
partially milling grains of the brown rice;
wetting the partially milled grains by forcing the grains into moist air;
tempering moisture of the wetted grains;
steam-boiling the tempered grains with steam at normal pressure;
steam-boiling the grains processed by said normal pressure steam-boiling step with pressurized steam;
cooling the grains processed by said pressurized steam-boiling step to reduce heat on the grains;
finish-milling the grains processed by said cooling step; and
drying the finish-milled grains to obtain grains of the parboiled rice, wherein amounts of γ-aminobutyric acid contained in the grains of parboiled rice are enriched.

7. Parboiled rice according to claim 6, wherein the grains are forced into moist air having temperature not less than 50° C. and humidity not less than 90% in said wetting step.

8. Parboiled rice according to claim 6, wherein the grains are wetted until the grains have moisture in a range between 16% and 19% by weight in said wetting step.

9. Parboiled rice according to claim 6, wherein the grains are tempered with temperature of the grains maintained at or above 50° C. in said tempering step.

10. Parboiled rice according to claim 6, wherein the grains are partially milled with germ remaining in said partially milling step.

11. A method of producing parboiled rice from brown rice, comprising the steps of:
partially milling grains of the brown rice;
wetting the partially milled grains by mist of water;
tempering moisture of the wetted grains;
steam-boiling the tempered grains with steam at normal pressure;
steam-boiling the grains processed by said normal pressure steam-boiling step with pressurized steam;
cooling the grains processed by said pressurized steam-boiling step to reduce heat on the grains;
finish-milling the grains processed by said cooling step; and
drying the finish-milled grains to obtain grains of the parboiled rice.

12. A method of producing parboiled rice according to claim 11, wherein the grains are wetted at a moisture increase rate between 0.5% and 0.8% by weight per hour in said wetting step, and said wetting step and said moisture-tempering step are repeatedly performed alternatively until the grains have moisture in a range between 17% and 19% by weight.

13. A method of producing parboiled rice according to claim 11, wherein the grains are partially milled with germ remaining in said partially milling step.

14. Parboiled rice produced by a method comprising the steps of:
partially milling grains of the brown rice;
wetting the partially milled grains by mist of water;
tempering moisture of the wetted grains;
steam-boiling the tempered grains with steam at normal pressure;
steam-boiling the grains processed by said normal pressure steam-boiling with pressurized steam;
cooling the grains processed by said pressurized steam-boiling to reduce heat on the grains;
finish-milling the grains processed by said cooling step; and
drying the finish-milled grains to obtain grains of the parboiled rice.

15. Parboiled rice according to claim 14, wherein the grains are wetted at a moisture increase rate between 0.5% by weight per hour and 0.8% by weight per hour in said wetting step, and said wetting step and said moisture-tempering step are repeatedly performed alternatively until the grains have moisture in a range between 17% and 19% by weight.

16. Parboiled rice according to claim 14, wherein the grains are partially milled with germ remaining in said partially milling step.
